(19) United States
(12) Patent Application Publication
(10) Pub. No.: US 2005/0182796 A1
(43) Pub. Date: Aug. 18, 2005

(54) Method and system for protecting data associated with a replaced image file during a re-provisioning event

(75) Inventors: Simon C. Chu, Chapel Hill, NC (US); Richard A. Dayan, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/777,509

(22) Filed: Feb. 12, 2004

(51) Int. Cl. G06F 17/30

(52) U.S. Cl. 707/200

(57) ABSTRACT

The present invention discloses a method and hard disk configuration for protecting data associated with a first image file in an appliance server after the first image file has been replaced with a second image file. In a first aspect, the method of the invention includes partitioning a hard disk of the appliance server into a plurality of partitions, wherein at least one of the plurality of partitions is a hidden partition and copying the data associated with the first image file to the hidden partition, wherein the data in the hidden partition is invisible to a network operating system during normal server operation. In another aspect, the hard disk of the invention includes a first partition for storing an image file, wherein the first partition stores one image file at one time, a second partition for storing data associated with the image file, wherein the second partition is visible to a network operating system in the first partition, a hidden partition, wherein the hidden partition is invisible to the network operating system in the first partition, means for replacing a first image file in the first partition with a second image file, and means for copying the data associated with the first image file from the second partition to the hidden partition when the first image file in the first partition is replaced with the second image file.

### FIELD OF THE INVENTION

The present invention relates to servers utilized to host applications, and in particular to a method and system for protecting data associated with a replaced image file during a re-provisioning event.

### BACKGROUND OF THE INVENTION

In a modern business computing environment, a collection of interconnected but separate servers, known as a server farm, is used to provide Internet web hosting service to a plurality of client businesses. An Internet Service Provider (ISP) will typically designate a separate server or group of servers for each business application being hosted. Multiple servers (or server groups) with different applications are controlled by the ISP and make up the server farm which is coupled to the Internet.

Server farms typically utilize appliance servers, which are standard servers that operate a specific application via a specific operating system (OS), i.e., single-focused servers or server groups. The application, associated operating system and corresponding files are collectively referred to as an image file. Throughout this description, the terms “image file” and “application” will be used interchangeably. When the image file running on a particular server is replaced with another image file, e.g., because the ISP must accommodate a second application and all available servers are already being utilized, the server is re-provisioned or re-purposed.

An automatic re-provisioning method is described in U.S. Pat. No. 6,636,958, entitled, “Appliance Server With A Drive Partitioning Scheme That Accommodates Application Growth In Size,” which is assigned to the assignee of the present invention. There, the disk drive of a server to be utilized as an appliance server is partitioned into at least our partitions,including a system partition, a network operating system (NOS) partition, a customer data partition and an images partition. A re-provisioning tool removes a first image file from the NOS partition of the server and stores it elsewhere, i.e., remotely, on the network, or in a storage partition of the local disk. The re-provisioning tool also installs a second image file on the server from the images partition, and causes the system to re-boot to provide full operation of the second application. Note that in certain circumstances, the re-provisioning tool will not be required to replace the network operating system because it may be common to the first and second applications.

The above-described process allows the ISP to re-provision the server quickly and with little or no human intervention. Nevertheless, in order to minimize the processing time, the information associated with the replaced image file in the customer data partition remains, i.e., it is not removed from the data partition, because to do so would require additional time and bandwidth, both of which are limited. Accordingly, the second or replacing image file can potentially access customer data associated with the first or replaced image file. If the first and second applications belong to one client and the customer data is related to that one client, then such access may not be a concern. If, however, the first application and second applications are owned by different clients, then access to the customer data associated with the replaced application presents a serious security breach.

Accordingly, a need exists for a system and method for allowing two or more clients to share a server in a server farm. The system and method should protect customer data associated with a replaced image file from potential access by a replacing image file after a re-provisioning event. The system and method should prevent such access and should also be transparent to the clients and to the service provider. The present invention addresses

### SUMMARY OF THE INVENTION

The present invention is related to a method and hard disk configuration for protecting data associated with a first image file in an appliance server after the first image file has been replaced with a second image file. In a first aspect, the method of the invention includes partitioning a hard disk of the appliance server into a plurality of partitions, wherein at least one of the plurality of partitions is a hidden partition and copying the data associated with the first image file to the hidden partition, wherein the data in the hidden partition is invisible to a network operating system during normal server operation. In another aspect, the hard disk of the invention includes a first partition for storing an image file, wherein the first partition stores one image file at one time, a second partition for storing data associated with the image file, wherein the second partition is visible to a network operating system in the first partition, a hidden partition, wherein the hidden partition is invisible to the network operating system in the first partition, means for replacing a first image file in the first partition with a second image file, and means for copying the data associated with the first image file from the second partition to the hidden partition when the first image file in the first partition is replaced with the second image file.

Through the aspects of the present invention, a hidden partition in the hard disk is used to store a customer data partition associated with a replaced image file after a re-provisioning event. By storing the data partition in the hidden partition, the operating system associated with the replacing image file, i.e., the active or network OS, is oblivious to the existence of that data partition. In this manner, two or more clients can share a server by re-provisioning the server when needed, while protecting their respective data from access by others.

### BRIEF DESCRIPTION OF THE DRAWINGS

FIG. 1 is a block diagram of a data processing system according to the preferred embodiment of the present invention.

FIG. 2 is a block diagram illustrating a partitioned hard disk.

FIG. 3 illustrates an appliance server system with automatic re-provisioning functionality.

FIG. 4 illustrates the hard disk of an appliance server according to a preferred embodiment of the present invention.

FIG. 5 is a flowchart illustrating a method for protecting customer data in a data partition after a re-provisioning event according to a preferred embodiment of the present invention.

### DETAILED DESCRIPTION

The present invention relates to servers utilized to host applications, and in particular to a method and system for protecting data associated with a replaced image file during a re-provisioning event. The following description is presented to enable one of ordinary skill in the art to make and use the invention and is provided in the context of a patent application and its requirements. While a preferred embodiment of the present invention involves a server farm, various modifications to the preferred embodiment and the generic principles and features described herein will be readily apparent to those skilled in the art. Thus, the present invention is not intended to he limited to the embodiment shown but is to be accorded the widest scope consistent with the principles and features described herein.

In a preferred embodiment of the present invention, the hard disk of a server is partitioned with a protected and hidden partition. The contents of the hidden partition are invisible to the network operating system. During a re-provisioning event from a first application to a second application, the data partition associated with the first application is copied to the hidden partition and the data partition associated with the second application is taken from the hidden partition, if it exists, and restored as the active data partition. By storing the data partition associated with an inactive application in the hidden partition, a single server can be shared by two or more clients, while protecting an inactive client's data from access by the active client's application/OS.

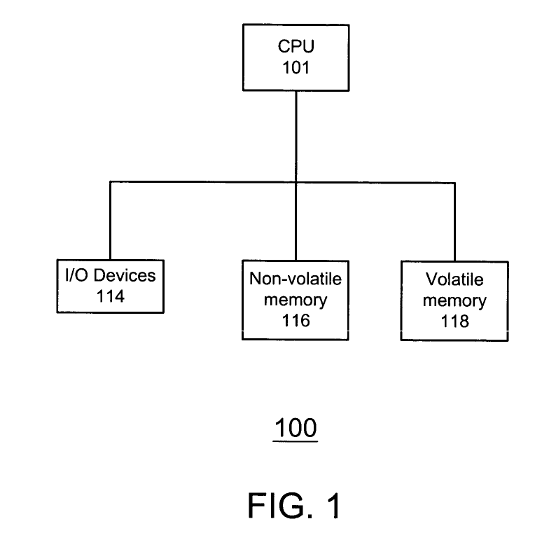

Referring now to FIG. 1, a block diagram illustrates a data processing system 100 according to the preferred embodiment of the present invention. Data processing system 100, such as an appliance server, has at least one central processing unit (CPU) 101 which is connected to several peripheral devices including input/output devices 114 for user interface. Other peripheral devices include a non-volatile memory 116, such as a hard disk, for storing the system's operating system and user programs/applications, and a temporary memory device 118 that is utilized by the CPU 101 while executing program instructions. Those skilled in the art will appreciate the above described processing system 100 can include other components that can be utilized in conjunction with those shown in FIG. 1.

In a preferred embodiment, the hard disk 116 is partitioned to support the functional features of the invention. In particular, the hard disk 116 is formatted to include a series of congruent, logical partitions, which are well known in the art. The preferred embodiment of the invention is implemented within the limit imposed by legacy compatibility of three (3) primary partitions and one (1) data partition on a disk 116. The primary partitions include a systems partition and an images partition in addition to the needed partitions for the operating system to work as normal.

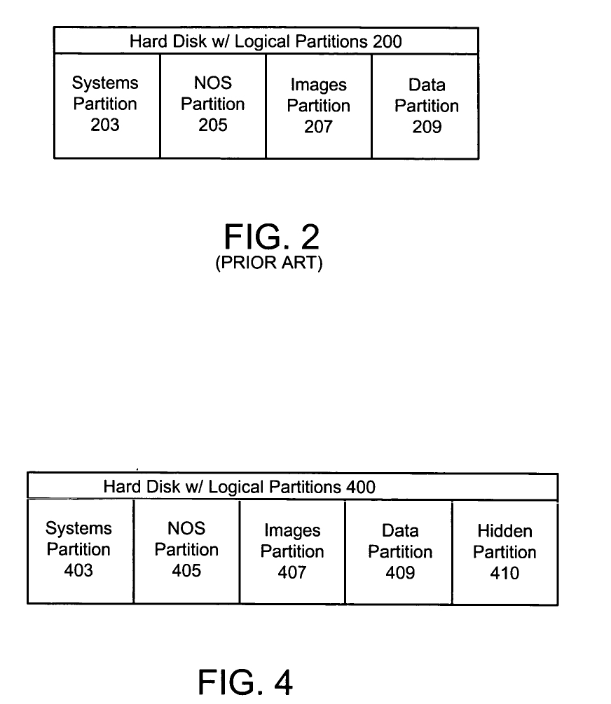

FIG. 2 is a block diagram illustrating a partitioned hard disk. As is shown, the hard disk is partitioned into four partitions, i.e., logical drives, including a system partition 203, network operating systems (NOS) partition 205, and images partition 207. A fourth partition, the data partition 209, is also provided. The system partition 203 comprises an operating system (OS) for the system, such as DOS or Linux. The NOS partition 205 comprises an image file for normal operation of the server during web-hosting, for example. The image file includes an application program(s) and optionally an associated operating system. The images partition 207 stores one or more image files that are inactive. The data partition 209 stores default settings, installation parameters of the system, and data associated with the active image file in the NOS partition 205.

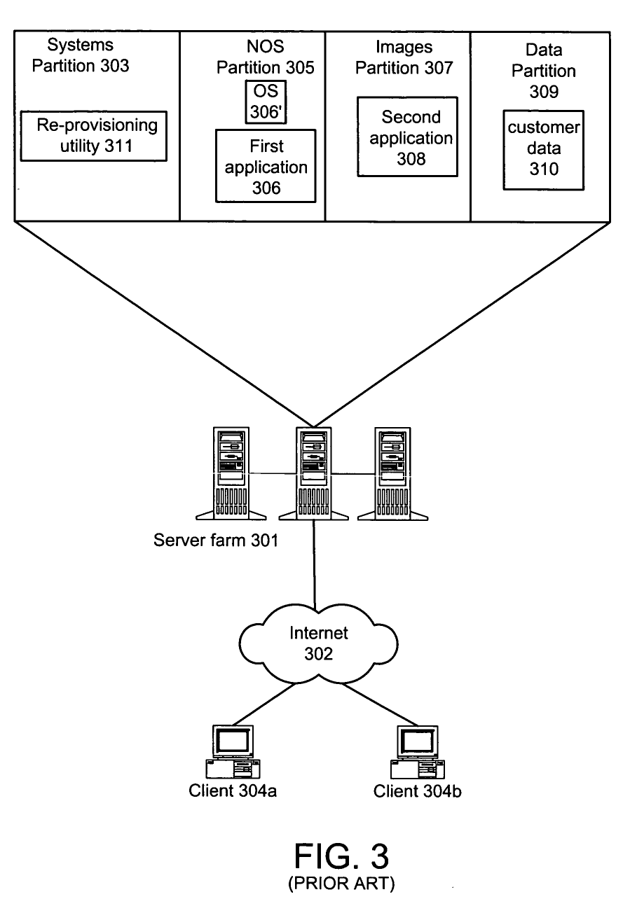

FIG. 3 illustrates an appliance server system with automatic re-provisioning functionality. Appliance server rack 301 is connected to Internet 302 and may be accessed by client system 304 via Internet 302. Appliance server rack 301 comprises several appliance servers. The topology of one hard disk of one server is illustrated with drive partitions 303-309. First application 306 contained in NOS partition 305, may be replaced with second (new) application 308. During normal operation, the application that is currently in NOS partition 305 determines the functionality of the appliance server. Re-provisioning involves the removal of the first application 306, as well as the associated OS 306′, from the NOS partition 305, and the subsequent loading of the second application 308 into the NOS partition 305. Second application 308 may exist in local storage, i.e., images partition 307, or at an application storage location on the network.

When the first application 306 is replaced during a re-provisioning event, a re-provisioning utility 311 wraps/packages and forwards the first application 306, along with its OS 306′, to a storage location, that may be the images partition 307 or a networked location. The associated data 310 in the data partition 309, however, is not removed from the data partition 309 because to do so would significantly degrade performance. Thus, as stated above, the second application 308 can access the data 310 in the data partition 309, which presents serious security issues if the first application 306 and the second application 308 are owned by different business clients 304a, 304b.

To address this problem, a preferred embodiment of the present invention provides a hidden partition on the hard disk. FIG. 4 illustrates the hard disk 400 of an appliance server according to a preferred embodiment of the present invention. As is shown, the hard disk 400 is partitioned into five partitions, including a systems partition 403, NOS partition 405, images partition 407, data partition 409 and a hidden partition 410. In a preferred embodiment, the hidden partition 410 is a portion of the hard disk 400 that is created using the SETMAX command as defined in the ATA/ATAPI-4(NCITS 317-1998) or equivalent. Those skilled in the art would readily appreciate that for different types of hard files, different commands can create analogous hidden portions of the hard disk. The server's firmware presumably supports the firmware (BIOS) interface for accessing the area of the ATA drive that is normally hidden via the SETMAX command. For an ATA drive, this firmware interface, known as Protected Area RunTime Interface Extension Services (PARTIES), allows an operating system to access the hidden partition. The PARTIES hidden partition is well known to those skilled in the art and further elaboration is not necessary. Alternatively, the hidden partition 410 can be supported in SCSI hard files.

According to the preferred embodiment of the present invention, multiple data partitions, each associated with an inactive image file, can be stored in the hidden partition 410. This information is inaccessible by an active application in the NOS partition 405 because a partition table in the hard disk's master boot record does not include an entry pointing to the hidden partition 410. Accordingly, the hidden partition 410 and its contents are invisible to the active application, and its associated OS, in the NOS partition 405.

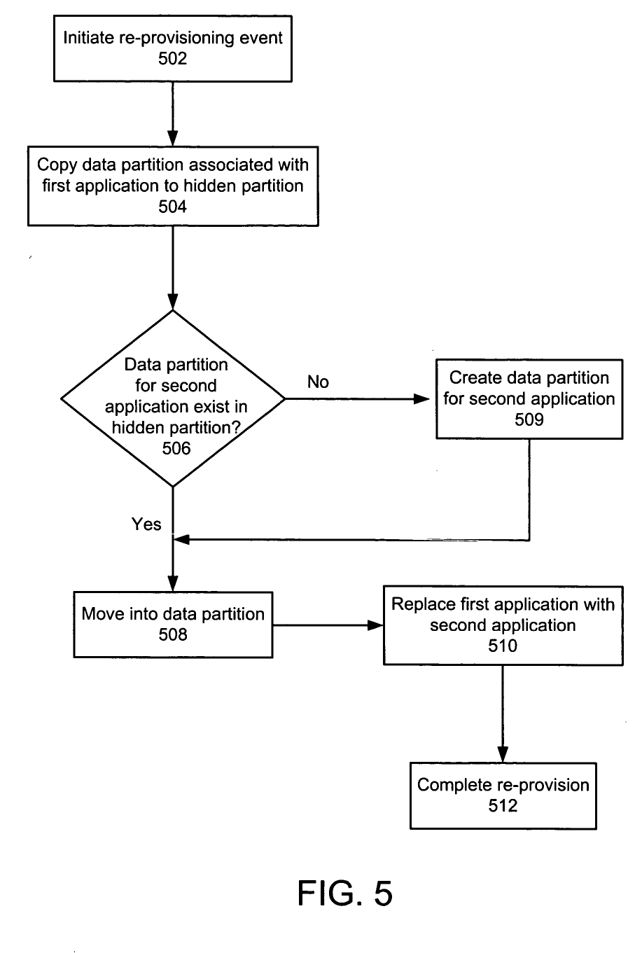

To illustrate how the hidden partition 410 is utilized, please refer now to FIG. 5, which is a flowchart for protecting customer data in a data partition after a re-provisioning event according to a preferred embodiment of the present invention. In step 502, a re-provisioning event is initiated. During this step, the re-provisioning utility 311 (FIG. 3) prepares the server for the re-provisioning by copying system ID and IP address information to the images partition 407 and fetching the second application 308 from the network, if needed, and storing it in the images partition 407. Next, the re-provisioning utility 311 changes the system partition 403 from inactive to active and the system partition 403 is re-booted into the server's OS (e.g., DOS or Linux). At this point, the NOS partition 405 is inactive, and re-provisioning can proceed.

Referring again to FIG. 5, in step 504, the data partition 310 associated with the first application 306 is copied to the hidden partition 410 (FIG. 4) and a determination is made in step 506 whether a data partition associated with the second application 308 exists in the hidden partition 410. If such a data partition exists, it is moved from the hidden partition 410 into the visible data partition 409 (step 508). Otherwise, a new data partition for the second application 308 is created (step 509) and placed in the visible data partition 409. At this point, the customer data 310 associated with the first application 306 is no longer in the visible data partition 409, and is therefore, protected from access by any application running in the NOS partition 405.

In step 510, the system partition 403 replaces the first application 306 with the second application 308, and then in step 512, the re-provisioning event is completed. Completing the re-provision event includes wrapping/packaging the first application 306, as well as the associated OS 306′ if appropriate, into a single image file, compressing it and forwarding the compressed image file to a storage location. After the second application 308 has been installed in the NOS partition 405, the system partition 403 is set inactive and the NOS partition 405 is active. To complete the re-provisioning event, the server re-boots to the OS associated with the second application 308 in the NOS 405 partition for normal appliance operation.

Through aspects of the preferred embodiment of the invention, customer data in a data partition associated with an image file is copied to the hidden partition when the image file is replaced by another image file during a re-provisioning event. The customer data stored in the hidden partition is invisible to any image file operating normally in the NOS partition. Accordingly, a plurality of clients can share one server without the fear of exposing the private data of one client to another client. In one example, an ISP can divide the Quality of Server (QoS) from a single server between unrelated customers or direct competitors, while ensuring its customers that access to their respective private data is protected from the other participants.

Although the present invention has been described in accordance with the embodiments shown, one of ordinary skill in the art will readily recognize that there could be variations to the embodiment and those variations would be within the spirit and scope of the present invention. For example, while the hidden partition of the preferred embodiment is a PARTIES partition, those skilled in the art would readily recognize that the hidden partition could also be supported by SCSI hard disks. Accordingly, many modifications may be made by one of ordinary skill in the art without departing from the spirit and scope of the appended claims.

1. A method for protecting data associated with a first image file after the first image file has been replaced with a second image file in an appliance server, the method comprising:
a) partitioning a hard disk of the appliance server into a plurality of partitions, wherein at least one of the plurality of partitions is a hidden partition; and
b) copying the data associated with the first image file to the hidden partition, wherein the data in the hidden partition is invisible to a network operating system during normal server operation.

2. The method of claim 1, wherein the at least one hidden partition is created using a SETMAX command.

3. The method of claim 1, wherein the at least one hidden partition is adapted to store data associated with a plurality of image files.

4. The method of claim 3 further comprising:
c) initiating a re-provisioning event prior to copying step (b); and
d) determining whether the hidden partition includes data associated with the second image file.

5. The method of claim 4 further comprising:
e) placing the data associated with the second image in a data partition of the plurality of partitions if the hidden partition includes such data, wherein the data partition is visible to the network operating system during normal server operation.

6. The method of claim 5 further comprising:
f) replacing the first image file with the second image file; and
g) completing the re-provisioning event.

7. The method of claim 1, wherein the image file includes an application, files required for installation and execution of the application and, when the application requires a corresponding operating system to operate, additional files for the corresponding operating

8. A computer readable medium containing program instructions for protecting data associated with a first image file after the first image file has been replaced with a second image file in an appliance server, the instructions for:
a) partitioning a hard disk of the appliance server into a plurality of partitions, wherein at least one of the plurality of partitions is a hidden partition; and
b) copying the data associated with the first image file to the hidden partition, wherein the data in the hidden partition is invisible to a network operating system during normal server operation.

9. The computer readable medium of claim 8, wherein the at least one hidden partition is created using a SETMAX command.

10. The computer readable medium of claim 8, wherein the at least one hidden partition is adapted to store data associated with a plurality of image files.

11. The method of claim 10 further comprising:
c) initiating a re-provisioning event prior to copying instruction (b); and
d) determining whether the hidden partition includes data associated with the second image file.

12. The computer readable medium of claim 11 further comprising:
e) placing the data associated with the second image in a data partition of the plurality of partitions if the hidden partition includes such data, wherein the data partition is visible to the network operating system during normal server operation.

13. The computer readable medium of claim 8 further comprising:
f) replacing the first image file with the second image file; and
g) completing the re-provisioning event.

14. A hard disk comprising:
a first partition for storing an image file, wherein the first partition stores one image file at one time;
a second partition for storing data associated with the image file, wherein the second partition is visible to a network operating system in the first partition;
a hidden partition, wherein the hidden partition is invisible to the network operating system in the first partition;
means for replacing a first image file in the first partition with a second image file; and
means for copying the data associated with the first image file from the second partition to the hidden partition when the first image file in the first partition is replaced with the second image file.

15. The hard disk of claim 14, wherein the hidden partition is created using a SETMAX command.

16. The hard disk of claim 14, wherein the hidden partition is adapted to store data associated with a plurality of image files.

17. The hard disk of claim 16, wherein the hard disk further comprises means for determining whether the hidden partition includes data associated with the second image file, and placing the data associated with the second image in the second partition if the hidden partition includes such data.

18. The hard disk of claim 14, wherein the image file includes an application, files required for installation and execution of the application and, when the application requires a corresponding operating system to operate, additional files for the corresponding operating system.

19. A data processing system comprising:
a processor;
a storage medium coupled to the processor, wherein the storage medium includes:
a first partition for storing an image file, wherein the first partition stores one image file at one time;
a second partition for storing data associated with the image file, wherein the second partition is visible to a network operating system in the first partition; and
a hidden partition, wherein the hidden partition is invisible to the network operating system in the first partition; and
logic associated with the storage medium for replacing a first image file in the first partition with a second image file, and copying the data associated with the first image file from the second partition to the hidden partition when the first image file in the first partition is replaced with the second image file.

20. The data processing system of claim 19, wherein the logic includes code for determining whether the hidden partition includes data associated with the second image file, and placing the data associated with the second image in the second partition if the hidden partition includes such data.

21. A method for providing a service that allows at least two clients to share a data processing system while protecting data associated with each of the at least two clients, wherein an active client controls the data processing system at any one time and any other client is inactive, the method comprising:
a) partitioning a hard disk of the data processing system into a plurality of partitions, wherein at least one of the plurality of partitions is a hidden partition; and
b) copying the data associated with any inactive client to the hidden partition, wherein the data in the hidden partition is invisible to a network operating system during normal operation of the data processing system.

22. The method of claim 21 further comprising:
c) allowing an inactive client to become a new active client by replacing an old
d) determining whether the hidden partition includes data associated with the new active client; and
e) placing the data associated with the new active client in a data partition of the plurality of partitions if the hidden partition includes such data, wherein the data partition is visible to the network operating system during normal operation.

23. The method of claim 22 further comprising:
f) removing the data associated with the old active client from the data partition; and
g) copying the data associated with the old active client to the hidden partition.
